(19) United States
(12) Patent Application Publication
(10) Pub. No.: US 2015/0141151 A1
(43) Pub. Date: May 21, 2015

(54) SYSTEM FOR GAME CREATION AND EXECUTION

(71) Applicant: Brassie Technologies, LLC, Lincoln, NE (US)

(72) Inventors: Mark Wible, Lincoln, NE (US); Nick Graef, Lincoln, NE (US); Eric Hess, Lincoln, NE (US); Aaron Brodersen, Lincoln, NE (US)

(21) Appl. No.: 14/540,685

(22) Filed: Nov. 13, 2014

Related U.S. Application Data
(60) Provisional application No. 61/904,367, filed on Nov. 14, 2013.

(51) Int. Cl. A63F 13/67; A63F 13/46

(52) U.S. Cl. CPC A63F 13/67; A63F 13/46
USPC 463/42

(57) ABSTRACT

The present invention discloses a game creation engine which includes a software module which allows users to develop, change or modify rules for an on-line game. According to one aspect of the present invention, the invention includes a game creation engine, a database for storing player data, a game scoring engine and a web-based or mobile interface through which players may input updated player data.

### RELATED APPLICATIONS

The present application claims priority to U.S. Provisional Application No. 61/904,367 filed Nov. 14, 2013.

### FIELD OF INVENTION

The present invention is related in general to a system for game creation and execution and, in particular, to a system for creating new or modified rules for an existing game.

### BACKGROUND OF THE INVENTION

Real-time online games are among the most popular games currently available. For these games, server and cloud based information systems are often utilized as gaming machines which centrally manage the play and scores of several players. To use these systems, players enter scores into a wireless or Internet enabled device which communicates with a central communications center to coordinate group play. In these systems, players or player groups may be separated by relatively long distances which cause their playing experiences to be diminished due to delays in communicating scores and results. Additionally, due to the centralized nature of the gaming machines, players are required to play with a given set of rules and are unable to customize the game rules to their preferences.

Based on the foregoing, there is a need for a system which allows for the dynamic and easy creation and modification of existing game rules. Further, there is a need for a system to share rule modifications and user-created games between players. Finally, there is a need for a system to allow players to dynamically receive scoring results based on updated and modified rules. The present invention overcomes prior art shortcomings by accomplishing these critical objectives.

### SUMMARY OF THE DISCLOSURE

To minimize the limitations found in the prior art, and to minimize other limitations that will be apparent upon the reading of the specification, the preferred embodiment of the present invention provides a system for the creation, modification and execution of rules for an on-line game.

The present invention includes a game creation engine, a database for storing player data, a game scoring engine and a web-based or mobile interface through which the player inputs the updated player data. The game creation engine includes a software module which allows users to develop, change or modify rules for a game.

In accordance with one embodiment of the present invention, the game engine provides a visual drag-and-drop interface whereby non-technical users may drag-and-drop instructions for new game rules or modifications to existing rules. In another embodiment, the game engine provides an interface which allows more technical users to create or modify game rules using a programming language. In still another embodiment, the game engine provides an interface for allowing users to create or modify game rules via natural language text input. In another embodiment, the game engine is a combination of these inputs.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and to improve the understanding of the various elements and embodiments of the invention. Furthermore, elements that are known to be common and well understood to those in the industry are not depicted in order to provide a clear view of the various embodiments of the invention. Thus, it should be understood that the drawings are generalized in form in the interest of clarity and conciseness.

FIG. 1 is a block diagram of a system for the creation and execution of rules in a game in accordance with a first preferred embodiment of the present invention.

FIG. 2 is a flow diagram of a system for the creation, modification and execution of rules in a game in accordance with a further preferred embodiment of the present invention.

### DETAILED DESCRIPTION OF THE DRAWINGS

Various inventive features are described below which can be used independently of one another or in combination with other features. However, any single inventive feature may not address any of the problems discussed above or only address one of the problems discussed above. Further, one or more of the problems discussed above may not be fully addressed by any of the features described below.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of complied C++, Java, HTML, or any other programming or scripting code such as R, Python and/or Excel. Further, the present invention teaches the use of processors to perform the functionalities and processes described herein. As such, processor is understood to mean the computer chip or processing element that executes the computer code needed for the performance of a specific action.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

The terms “computer,” “engine,” “module,” “processor” and the like should be understood to be synonymous for the purposes of this disclosure. Additionally, any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

Reference is now made in detail to the exemplary embodiments of the invention, examples of which are illustrated in the accompanying drawings. Wherever possible, the same reference numbers will be used throughout the drawings to refer to the same or like parts. It should be understood that throughout this disclosure, unless logically required to be otherwise, where a process or method is shown or described, the steps of the method may be performed in any order or simultaneously. As used throughout this application, the word “may” is used in a permissive sense (i.e., meaning “having the potential to’), rather than the mandatory sense (i.e. meaning “must”).

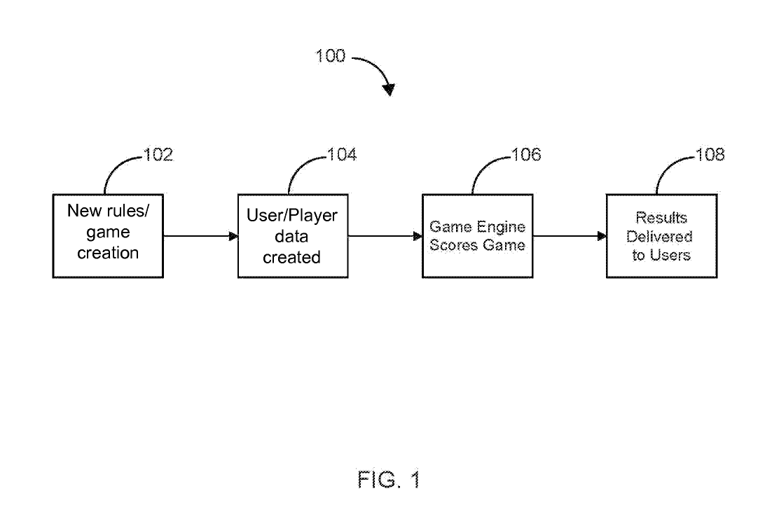

FIG. 1 is a block diagram of an exemplary system 100 for the storage, modification and execution of an on-line game in accordance with a first preferred embodiment of the present invention. As shown, the system includes a first module 102 which allows a user to create a new game or modify rules to an existing game. Preferably, the first module 102 operates as a software module or set of computer code residing on a mobile device. Alternatively, the first module may reside on any other computing device with access to a computer network. After the new game or modified rules are created, the updated game changes are preferably submitted to the game engine 106 for storing and administration.

Once the game engine 106 is updated, the players are then able to input their player created data (i.e. scores, progress, times, etc.) into the system via an input module 104 for evaluation based on the updated game data. Preferably, the system may also evaluate previously stored player created data based on the updated game data. As player created data is inputted and evaluated by the game engine 106, a delivery module 108 is provided to transmit and dynamically update players based on the game rules.

In one embodiment, the modules 102 and 106 may provide a visual drag-and-drop interface for non-technical users. in another embodiment, the modules 102 and 106 may further include a technical interface for changing game rules via a standard programming language. In yet another embodiment, the modules 102 and 106 may farther include an interface for changing game rules via a natural language text input. Still further, in yet another embodiment, the modules 102 and 106 may together include a combination of these input interfaces.

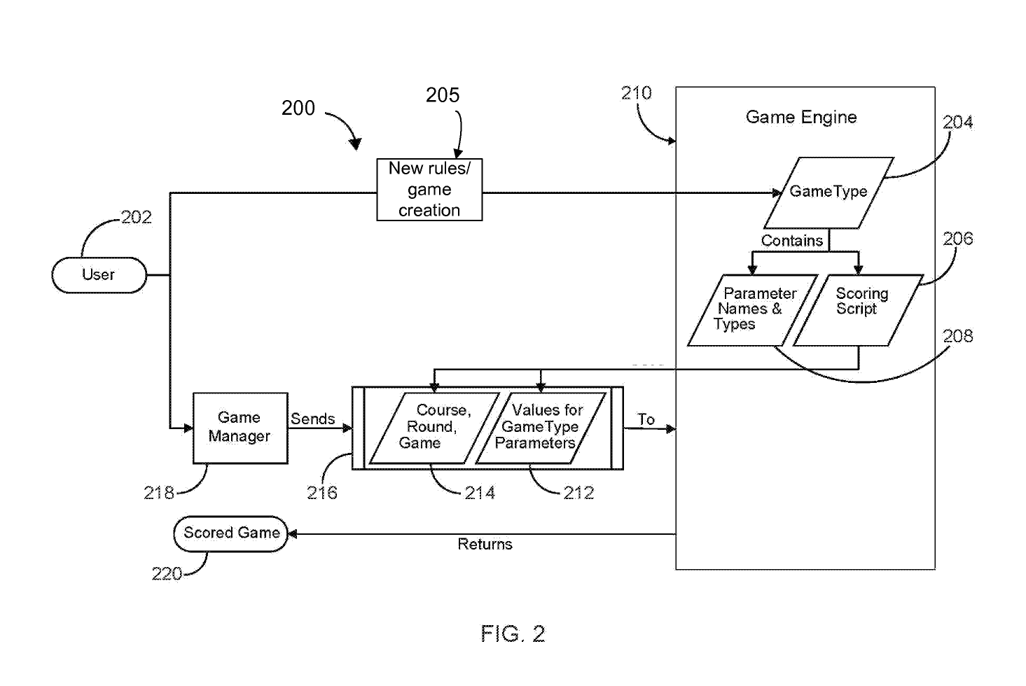

With reference now to FIG. 2, a more detailed discussion of an exemplary system in accordance with a. preferred embodiment of the present invention will now be discussed. As shown in FIG. 2, a user 202 may access the system 200 to create a new game or to modify an existing set of game rules. As shown, the user 202 may preferably access the system 200 via the new rules/game creation module 205. Preferably, the new rule/game creation module 205 may be, for instance, an application running on a mobile device.

Using the new rule/game creation module 205, the user 202 may create game rules for player data by selecting the desired game type and the parameters, variables and/or scoring scripts for the selected game. The selected games, variables and/or scoring scripts may preferably be made by selection from a pull-down menu or the like. Alternatively. the user 202 may utilize programming or natural text language to define the needed parameters and scoring scripts. According to a. further embodiment, a visual interface 220 may also be provided for a user 202. In one embodiment, the game rules may preferably be created using a drag-and-drop interface similar to Visio or LabView programming environments.

Once selected, the game engine 210 preferably stores the user input by game type 204 (i.e. golf, poker, orienteering). Additionally, the game engine 210 accepts and stores inputs defining the parameters/variables 208 and associated scoring scripts 206 (i.e. algorithms for scoring and ranking; for each selected game. The game engine 210 thereafter preferably stores the game rules on a database or similar storage option.

Prior to play, the game scoring module 216 preferably receives game management data from the game engine 210 which may include formats for recording variables needed to score and manage a game. During play, the game scoring module 216 preferably receives player data from a game manager module 218. Once received, the game scoring engine 216 may preferably configure and store player data in accordance with the formats received from the game engine 210. These may include a listing of the course, round or game being played 214 (i.e. game status) and a list of variables 212 for a selected game, The calculations of the game scoring engine 216 may then be further processed by the game engine 210 as needed and provided to the players via web access or the like via an access module 220.

To further illustrate the present invention, an example use of the present invention will now be discussed with further reference to FIG. 2. According to this first example, a group of players may be participating in a golf tournament event. The golf tournament itself will be played according to established rules, such as stroke play. Using networked devices (i.e. mobile phones, tablets, laptops and the like), the players may input their data via a game manager module 218 as they play the golf tournament so that their scores can be tracked and presented to others. According to this aspect of the invention, the game scoring module 216 receives the data from the game manager module 218. Thereafter, the data is forwarded to the game engine 210 which calculates scores 206 as compared to other participating players who are also entering their data as they play in the golf tournament. When a player wishes to create a new game or rule, the player 202 may submit the new rule or game variation via the new rules/game creation module 205. Once created, the game modifications are preferably saved to the game engine 210 and made available to share with other users. Further, other users may create their own versions of the game rules and thereby create their own new modified game, Once created, each user may then invite other players to participate in the game using the modified rules. In response, a player can accept this invitation and participate in multiple games that will be scored based on a single set of player data. In this way, the players can play at the same golf course and in the same overall golf tournament, but they can also then participate in one or multiple games with different rules that are scored.

Within the system 200, when a user 202 creates a new game, the modified rules of the new game are stored in the game engine 210. Additionally, the game engine 210 may update the game scoring engine 216 for any new variables or scoring scripts. When a game needs to be re-scored due to a new rule, the game manager module 218 is preferably triggered by the system 200 to send input to the game scoring engine 216 and the game engine 210 to dynamically processes the player data and provide a real-time leaderboard or ranking back to the players under the new rules. The game creation engine 210 also stores the individual player data. Accordingly, a player may then analyze their player data for trends or hypothetically apply user created game rules to historical data to determine who would have hypothetically won a user created game based on the historical player data.

Additionally, the game scoring engine 216 may provide course location information to a player as shown in block 214. For example, the location for a vehicle-based beverage cart could be provided to the system 200. The system 200 could then provide a map to a player showing the location of the beverage cart. The estimated time in which the beverage cart will reach the player's location could also be provided, The player may also send messages through the system 200 to the beverage cart. For example, the player could indicate their desire to purchase a beverage or to place an order for a specific beverage. The payment processing may also be made via the system, so that cash payment does not need to be made directly between the player and the beverage cart operator.

The system of the present invention can be utilized in different sport activities. For example, rules for a user-created game and player data may be provided to the system corresponding to data for golf, bowling, target shooting, volleyball, billiards, etc. Regardless of the sport, the player data may be input to the system using an interface such as mobile application or the like. As discussed above, the user created game rules may then preferably applied to player data. In the golfing example above, the data provided to the system may include data such as stroke, distance, location, weather, equipment utilized, transportation, time, date, handicap, etc.

According to further preferred embodiment of the present invention, player data may be wirelessly transmitted to the system 200 according to known data logging methods and the data may be cached locally on the smart phone and later transmitted.

According to a preferred embodiment, the system 200 may be used to allow players to participate simultaneously in more than one game. According to this aspect of the present invention, the player data may be processed through every set of game rules for which a player is participating and various leaderboards may be used to show the rankings for the various games in which they are participating. According to a further aspect of the invention, the system may allow players to share their data and leaderboard updates via social media. Further, players may also send private group or direct messages to the other participants in a game. The system may also present other player data to the other players in a game. For example, a map may be presented to a player indicating where the other game players are located on the map.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto. The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A computer program product for use in a network connectable system, the computer program product comprising one or more computer readable storage media having encoded thereon computer executable instructions which, when executed upon by one or more computer processors, perform a method of creating and executing rules for an on-line game, the product comprising:
a rule creation module, wherein the rule creation module receives modifications to game rules;
a game manager module, wherein the game manager module receives player data regarding the performance of a player in a game;
a game scoring module, wherein the game scoring module receives player data and calculates game results by applying user designed rules to player data;
a game engine module for receiving modified rules from the rule creation module and for creating algorithms and variables based on the modified rules, wherein the game engine module transmits updated algorithms for calculating game results to the game scoring module based on the modified rules; further wherein the game engine module prompts the game manager module to send player data to the game scoring engine in response to receiving a rule modification; further wherein the game engine processes the player data provided by the game manager module and provides an updated player score based on the updated algorithms.

2. A method for creating and executing the rules of an on-line game, the method comprising:
receiving rule modification data regarding changes to the rules of an on-line game;
receiving player data regarding the performance of a player in the on-line game;
updating algorithms and variables to calculate game scores and rankings based on the rule modification data;
updating player data in response to receiving rule modification data; and
processing updated player data to create an updated player ranking based on the updated algorithms and variables applied in response to the rule modification data.
